(19) United States
(12) Patent Application Publication
(10) Pub. No.: US 2023/0041340 A1
(43) Pub. Date: Feb. 9, 2023

(54) DIGITAL WATERMARKING APPARATUS, DIGITAL WATERMARK EXTRACTION APPARATUS, DIGITAL WATERMARKING METHOD, DIGITAL WATERMARK EXTRACTION METHOD AND PROGRAM

(71) Applicant: NIPPON TELEGRAPH AND TELEPHONE CORPORATION, Tokyo (JP)

(72) Inventor: Fuyuki KITAGAWA, Tokyo (JP)

(73) Assignee: NIPPON TELEGRAPH AND TELEPHONE CORPORATION, Tokyo (JP)

(21) Appl. No.: 17/788,159

(22) PCT Filed: Dec. 25, 2019
(86) PCT No.: PCT/JP2019/050987

§ 371 Date: Jun. 22, 2022

(51) Int. Cl. G11B 20/00; H04L 9/08

(52) U.S. Cl. CPC G11B 20/00884; H04L 9/0866

(57) ABSTRACT

An electronic watermark embedding apparatus according to an embodiment is an electronic watermark embedding apparatus capable of embedding an electronic watermark into a decoding circuit of secret-key encryption, and includes an embedding unit configured to generate the decoding circuit. The decoding circuit is embedded with the electronic watermark by being input with a common parameter generated in a setup of the secret-key encryption, a secret key of the secret-key encryption, and the electronic watermark, and is capable of decoding an encrypted text encrypted using the secret-key encryption.

### TECHNICAL FIELD

The present invention relates to an electronic watermark embedding apparatus, an electronic watermark extraction apparatus, an electronic watermark embedding method, an electronic watermark extraction method, and a program.

### BACKGROUND ART

Electronic watermarks are widely used for techniques for ensuring the authenticity by embedding information on a proprietor or a creator into contents such as images and music. In addition, in an extension of the electronic watermarks, research is also being conducted on a technique called “program electronic watermark” in which any information is unremovably embedded in a program, with an operation of the program remained unchanged.

There are electronic watermarks for cryptographic functions as a type of the program electronic watermark, and many electronic watermarks have been proposed for pseudo-random functions (for example, NPLs 1 to 4). With the use of these pseudo-random functions, it is possible to realize secret-key encryption allowing an electronic watermark to be embedded in a decoding circuit.

### CITATION LIST

### Patent Literature

NPL 1: Aloni Cohen, Justin Holmgren, Ryo Nishimaki, Vinod Vaikuntanathan, and Daniel Wichs. Watermarking cryptographic capabilities. In Daniel Wichs and Yishay Mansour, editors, 48th ACM STOC, pages 1115-1127. ACM Press, June 2016.

NPL 2: Sam Kim and David J. Wu. Watermarking cryptographic functionalities from standard lattice assumptions. In Jonathan Katz and Hovav Shacham, editors, CRYPTO 2017, Part I, volume 10401 of LNCS, pages 503-536. Springer, Heidel-berg, August 2017.

NPL 3: Willy Quach, Daniel Wichs, and Giorgos Zirdelis. Watermarking PRFs under standard assumptions: Public marking and security with extraction queries. In Amos Beimel and Stefan Dziembowski, editors, TCC 2018, Part II, volume 11240 of LNCS, pages 669-698. Springer, Heidelberg, November 2018.

NPL 4: Sam Kim and David J. Wu. Watermarking PRFs from lattices: Stronger security via extractable PRFs. In Alexandra Boldyreva and Daniele Micciancio, editors, CRYPTO 2019, Part III, volume 11694 of LNCS, pages 335-366. Springer, Heidel-berg, August 2019.

### SUMMARY OF THE INVENTION

### Technical Problem

However, for example, in the techniques proposed in NPLs 1 to 4, when an electronic watermark is embedded or an electronic watermark is extracted, it is necessary to use confidential information (for example, an embedded key and an extraction key) generated when the electronic watermark system is set up. Thus, for example, a user other than a system administrator with the confidential information cannot embed or extract the electronic watermark.

An embodiment of the present invention has been made in view of the above-described circumstances, and an object thereof is to realize secret-key encryption allowing any user to embed an electronic watermark.

### Means for Solving the Problem

To achieve the above object, an electronic watermark embedding apparatus according to an embodiment is an electronic watermark embedding apparatus capable of embedding an electronic watermark into a decoding circuit of secret-key encryption. The electronic watermark embedding apparatus includes an embedding unit configured to generate a decoding circuit The decoding circuit embedded with the electronic watermark by being input with a common parameter generated in a setup of the secret-key encryption, a secret key of the secret-key encryption, and the electronic watermark, and is capable of decoding an encrypted text encrypted using the secret-key encryption.

### Effects of the Invention

It is possible to realize secret-key encryption allowing any user to embed an electronic watermark.

### BRIEF DESCRIPTION OF DRAWINGS

FIG. 1 is a diagram illustrating an example of an entire configuration of an electronic watermark embeddable encryption system according to the present embodiment FIG. 2 is a diagram illustrating an example of a processing flow executed by the electronic watermark embeddable encryption system according to the present embodiment.

FIG. 3 is a diagram illustrating an example of a hardware configuration of a computer.

### DESCRIPTION OF EMBODIMENTS

Hereinafter, an embodiment of the present disclosure will be described. In the present embodiment, an electronic watermark embeddable encryption system 1 for realizing secret-key encryption allowing any user to embed an electronic watermark into a decoding circuit, will be described. Here, the user is a person, a program, or the like other than a system administrator of the electronic watermark embeddable encryption system 1. On the other hand, the system administrator is a person, a program, or the like to set up the electronic watermark embeddable encryption system 1.

Note that embedding an electronic watermark may be referred to as, for example, “insertion of an electronic watermark” and the like. Similarly, extracting an electronic watermark may be referred to as, for example, “detection of an electronic watermark”, and the like.

Preparation Firstly, several notations, concepts, and the like are prepared prior to describing secret key encryption allowing for embedding an electronic watermark.

Notations

$$x {←}^{r} X \qquad [ Math . 1 ]$$

represents a uniform random selection of an element x from a finite set X. This will be hereinafter described as “x<-rX” as used herein.
y<−A (x; r) represents an algorithm A outputting y for an input x and a random number r, and is represented by simple description of “y<-A (x)” if the random number used by A is not required to be explicitly expressed. Furthermore,

[Math. 2]

[symbol]

represents a set of integers:

[Math. 3]

{1, . . . , [symbol] }

λrepresents a security parameter. If a function f(λ) converges to 0 faster than₁/XC for all constants c >0, then f is negligible. f(r)=negl (λ) is used to represent a certain function f being negligible. Also, a probabilistic polynomial time is abbreviated as PPT.

Decisional Diffie-Hellman Assumption Decisional Diffie-Hellman assumption, which is used as a basis for the safety of an electronic watermark embeddable secret key encryption, is defined as below.

G is a cyclic group of an order p and g is a generator of G. At this time, for all PPT algorithms A

[Math. 4]

|Pr[ [symbol] ( [symbol] ,p,g,g^{x}, [symbol] , [symbol] )=1]−Pr [ [symbol] ( [symbol] ,p,g,g^{x}, [symbol] ,g^{z})=1]=neg|(λ)|

holds. Here, x, y, z are selected randomly from Zₚ*. Note that Z_{P}*is a set obtained by removing a zero element from Zₚ=Z/pZ, where Zₚ is a residue system of Z modulo a prime number p.

Secret Key Encryption

Secret-key encryption (hereinafter also abbreviated as “SKE”) is configured by four PPT algorithms (Setup, KG, Enc, and Dec). The setup algorithm Setup is input with a security parameter 1 ^{λ}and outputs a common parameter pp. The key generation algorithm KG is input with the common parameter pp and outputs a key sk. The encryption algorithm Enc is input with the key sk and a plaintext:

[Math 5]

m∈

[symbol]

and outputs an encrypted text ct, where

[Math. 6]

[symbol]

a plaintext space. The decoding algorithm Dec is input with the key sk and the encrypted text ct and outputs a plaintext:

[Math. 7]

\tilde{m} ∈{⊥}∪ [symbol] .

The secret-key encryption requires that as a correctness, for all of

[Math. 8]

m∈

[symbol]

pp<-Setup (1^{λ}), and sk<-KG (pp), Dec (sk, Enc (sk, m))=m holds.

Indistinguishability for Chosen Plaintext Attack (IND-CPA Security) SKE means the secret-key encryption. An IND-CPA game performed by a challenger and an attacker A is defined by the following (1-1) to (1-3).

(1-1) The challenger generates a random bit b<-r{0, 1}. The challenger then generates pp<-Setup (1^{λ}) and sk<-KG (pp) and sends the common parameter pp to an attacker A.

(1-2) The attacker A can repeat a next encryption query. The attacker A sends

[Math. 9]

(m⁰,m¹)∈ [symbol] ²

as the encryption query to the challenger. For the encryption query, the challenger generates ct <-Enc (s^{k}, m^{b}) and returns an encrypted text ct to the attacker A.

(1-3) The attacker A outputs b′∈{0,1}.

At this time, if, for all PPT attackers A,

[Math. 10]

Adv_{SKE,A}^{indcpa}(λ)=|Pr[b=b′]−½|=neg|(λ)

holds, then SKE is considered IND-CPA secure.

Theoretical Configuration of Electronic Watermark Embeddable Secret Key Encryption

Next, a theoretical configuration of the electronic watermark embeddable secret-key encryption (watermarkable SED, hereinafter also abbreviated as “WME”) will be described. Note that the electronic watermark will be simply referred to as “watermark” below.

Definition of WME

WME is configured by six PPT algorithms (Setup, KG, Enc, Dec, Mark, and Ext). Hereinafter,

[Math. 11]

[symbol]

are considered a watermark space, an encrypted text space, and a plaintext space of the WME, respectively.
(Setup, KG, Enc, and Dec) configure secret key encryption.
Mark (pp, sk, M)->D: the common parameter pp, a secret key sk, and the watermark:

[Math. 12]M∈

[symbol]

are input and a decoding circuit D embedded with the watermark is output.
Ext (pp, C)->M: the common parameter pp and the circuit:

[Math. 13]

C: [symbol] → [symbol] ∪{⊥}

are input, and

[Math. 14]

M∈

[symbol]

or a symbol “unmarked” representing that the watermark is not embedded is output. Note that more precisely, C represents a description as a circuit (electronic circuit).

The WME satisfies the following extraction correctness and functional conservation.

Extraction correctness: for all of

[Math. 15]

M∈

[symbol]

pp<-Setup (1^{λ}), sk<-KG (pp), and D<-Mark (pp, sk, M), Ext (pp, D)=M holds.

Functional conservation: for all of

[Math. 16]

M∈

[symbol]

pp<-Setup (1)), sk<-KG (pp), and D<-Mark (pp, sk, m), D (Enc (sk, M))=m holds.

Note that the above extraction correctness intuitively ensures that it is possible to correctly extract, by Ext, a watermark embedded by Mark. Also, the above functional conservation ensures that it is possible to correctly decode the encrypted text generated using the Enc by the decoding circuit embedded with the watermark.

ε-Unremovability

The electronic watermark embeddable secret key encryption needs to satisfy e-unremovability defined below.

Here, the WME is the electronic watermark embeddable secret-key encryption. A removal game performed by the challenger and the attacker A is defined by the following (2-1) to (2-4).

[Math. 17]

[symbol]

_{enc}

will be employed below for a random number space of the algorithm Enc.

(2-1) The challenger generates pp<-Setup (1^{λ}) and sk<-KG (pp) and sends a common parameter pp to the attacker A.

(2-2) The attacker A can repeat a next encryption query. The attacker A sends

[Math. 18]

m∈

[symbol]

as the encryption query to the challenger. For the encryption query, the challenger generates ct <-Enc (sk, m) and returns an encrypted text ct to the attacker A.

(2-3) The attacker A sends

[Math. 19]

M∈

[symbol]

to the challenger. The challenger generates D<-Mark (pp, sk, M) and returns the decoding circuit D to the attacker A.

(2-4) The attacker A outputs a circuit:

[Math. 20]

C: [symbol] → [symbol] ∪{⊥}

The challenger outputs Ext (pp, C) as an output of the game. Note that more precisely, C represents a description as a circuit (electronic circuit).

It is required that the circuit C output by the attacker A in the above game satisfies the following condition:

[Math. 21]

Pr[C(Enc(sk, m; r))=m]≥ε

(that is, the circuit C is acceptable). Here, the above probability depends upon

[Math. 22]

m [symbol] ,r [symbol] _{enc},

which is a selection. At this time, for all the PPT attackers A, if the following:

[Math. 23]

A [symbol] (λ)=Pr[Ext(pp, C)≠M]=negl(λ)

is true, it is said that the WEM satisfies the ε-unremovability.

Specific Configuration of WME according to Present Embodiment Four Parators:

[Math. 24]

ρ, ϵ,ω,

[symbol]

are each set to ρ=1/poly₁(λ), ε=1/2+ρ, ε=λ/ρ², and

[Math. 25]

[symbol]

=poly₂(λ).

Here, poly₁ and poly₂ represent a polynomial.

At this time, in the present embodiment, an electronic watermark embeddable secret-key encryption WME=(Setup, KG, Enc, Dec, Mark, Ext) with the watermark space:

[Math. 26]

[symbol]

is configured as follows.

Setup (1^{λ}): A cyclic group G of an order p and a generator g of the cyclic group G are generated, and a common parameter pp: =(G, p, g) is output.

KG (pp): Firstly, for all

[Math. 27]

i∈[ [symbol] +1]

aᵢ<-ᵣZₚ*is generated,

[Math. 28]

gᵢ←g^{αi}

is established. Also, x<-ᵣZₚ is generated. Further, the secret key:

[Math. 29]

sk:=(g₁, . . . ,g [symbol] +1,x,α₁, . . . ,α [symbol] +1)

is output.

Enc (sk, m): Firstly, sk is parsed as follows:

[Math. 30]

(g₁, . . . ,g [symbol] +1,x,α₁, . . . ,αₗ+1)←sk.

Further, r<-ᵣZₚ is generated. Subsequently, an encrypted text:

[Math. 31]

ct:=(g₁^{r}, . . . , [symbol] ,m· [symbol] )

is output.

Dec (sk, ct): Firstly, sk and ct are parsed as follows:

[Math. 32]

(g₁, . . . ,g [symbol] +1,x,α₁, . . . ,αₗ₊₁)←sk [symbol] (c₁, . . . ,c [symbol] ₊₁,d)←ct.

Further, a decoding result:

[symbol]

[Math. 33]

d·

[symbol]

is output.

Mark (pp, sk, M): Firstly, pp is parsed into (G, g, p)<-pp, and sk and M is parsed as follows:

[Math. 34]

(g₁, . . . ,g [symbol] ₊₁,x,α₁, . . . ,α [symbol] ₊₁)←sk, [symbol] M=(M₁, . . . ,Mₗ)

[Math. 35]

α [symbol] ₊₁·x=α [symbol] ₊₁·\tilde{x}+ [symbol] aᵢMᵢ mod p

### Next,

[Math. 36]satisfying the [Math. 35] is calculated. A symbol with “-” above x is hereinafter represented as “x” as used herein.

Thereafter, a decoding circuit D [M, ˜x] having the following description is output. Note that the decoding circuit D [M, ˜x] is a description in which the encrypted text ct is input and a decoding result is output (a description as an electronic circuit).

Description of Decoding Circuit D [M, ˜x]

A value stored in the decoding circuit D (that is, a hard-coded value) is considered

[Math. 37]

M=(M₁, . . . ,Mₗ)∈{0,1 [symbol] ,\tilde{x} ∈

[symbol]

At this time, the decoding circuit D [M, ˜x] parses the input encrypted text ct as follows:

[Math. 38]

(c₁, . . . ,cₗ₊₁,d)←ct,

and outputs a decoding result:

[Math. 39]

$$d \cdot {c}_{ℓ + 1}^{\tilde{x}} \cdot {\prod }_{i ∈ [ ℓ ]} {c}_{i}^{{M}_{i}}$$

Ext (pp, C): Firstly, pp is parsed into (G, p, g)<-pp. Next,

[Math. 40]

[symbol]

+1 random [symbol] generators ĝ₁, . . . ,ĝ [symbol] ₊₁

is generated, and

[Math. 41]

ĥ←Findpk(ĝ₁, . . . ,ĝ [symbol] ₊₁,C)

is executed. A symbol with “∧” above h is hereinafter represented as “∧h” as used herein. Here, Findpk is a circuit that outputs either ∧h or ⊥(more accurately, a description as an electronic circuit). If Findpk outputs ⊥, then Ext outputs unmarked and the execution ends immediately.

Note that the description of the circuit Findpk will be described in detail later.

Subsequently, for all

[Math. 42]

i∈[ [symbol] ]

[Math. 43]

Mᵢ←Findmkᵢ(ĝ₁, . . . ,ĝ [symbol] ₊₁,ĥ,C)

is executed. Here, Findmki is a circuit that outputs either Mi or I (more precisely, a description as an electronic circuit). If Findmki outputs 1, then Ext outputs unmarked and the execution ends immediately. Note that the description of the circuit Findmki will be described in detail later.

Subsequently, the watermark:

### [Math. 44]

(M₁, . . . , [symbol] )

is output.

Descriptions of Circuit Findpk

For all j∈[ω], mⱼ <-ᵣG and rⱼ<-ᵣZₚ*are generated, and

[Math. 45]

[symbol]

ⱼ←C(ĝ₁^{rj}, . . . , [symbol] ,mⱼ ĥⱼ←(yⱼ·ⱼ⁻¹)^{1/rj}

are calculated.

Then, in ωvalues {∧hⱼ}_{j ∈[ω]}, if there is ∧h appearing ω/2 times or more, the ∧h is output, and if there is no such value, ⊥ is output.

Descriptions of Circuit Findmkᵢ

For all j∈[ω], mⱼ<-ᵣG and rⱼ<-ᵣZₚ*are generated, and

[Math. 46]

[symbol]

ₖ←C(ĝ₁^{rk}, . . . ,ĝᵢ₋₁^{rk},ĝᵢ^{rk+1},ĝᵢ₊₁^{rk}, . . . , [symbol] ,mₖ) [symbol] ₖ← [symbol] ₖ ·(mₖ·ĥᵣₖ ⁻¹5

are calculated.

Next, in ω values {zk}k∈[ω], a value z appearing ω/2 times or more is evaluated. If there is no such value, ⊥ is output.

Then, in the case where there is the value z appearing ω/2 times or more, if the value z =1, 0 is output, if the value z=∧ is output, and otherwise, 1 is output.

As described above, the WME=(Setup, KG, Enc, Dec, Mark, Ext) according to the present embodiment is configured. The WME thus configured is IND-CPA secure under the decisional Diffie-Hellman assumption. Under the decisional Diffie-Hellman assumption, e-unremovability is satisfied. Note that εis ε=1/2+ρ set above.

Entire Configuration

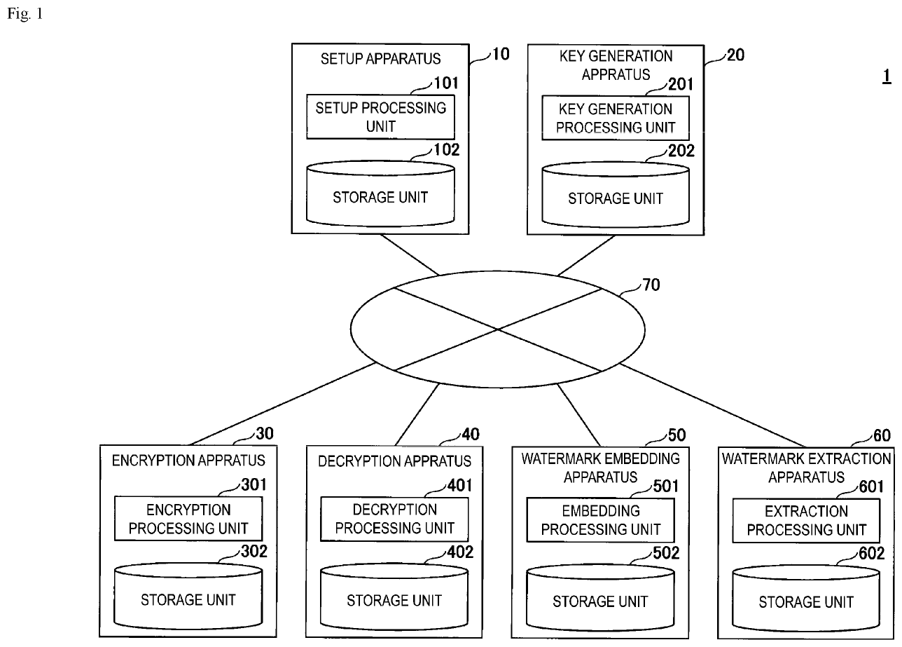

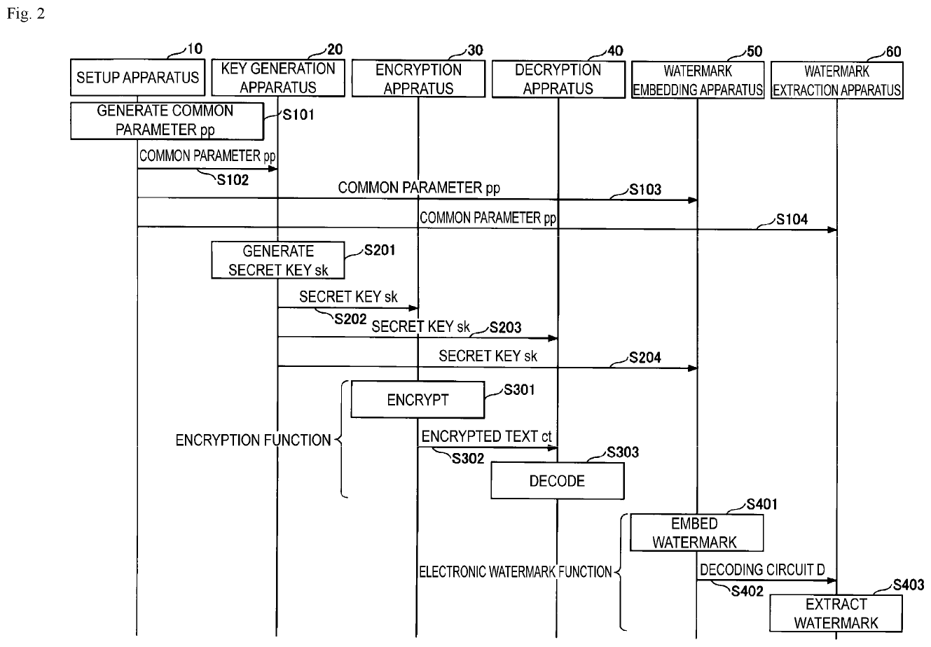

Next, an entire configuration of the electronic watermark embeddable encryption system 1 according to the present embodiment will be described with reference to FIG. 1. FIG. 1 is a diagram illustrating an example of the entire configuration of the electronic watermark embeddable encryption system 1 according to the present embodiment.

As illustrated in FIG. 1, the electronic watermark embeddable encryption system 1 according to the present embodiment includes a setup apparatus 10, a key generation apparatus 20, an encryption apparatus 30, a decryption apparatus 40, a watermark embedding apparatus 50, and a watermark extraction apparatus 60. These apparatuses are communicatively connected through any communication network 70 such as the Internet, for example. Note that, for example, the setup apparatus 10 is utilized by a system administrator, and the encryption apparatus 30, the decryption apparatus 40, the watermark embedding apparatus 50, and the watermark extraction apparatus 60 are utilized by a user. The key generation apparatus 20 may be utilized by the system administrator or may be utilized by the user.

The setup apparatus 10 is a computer or a computer system configured to set up a system. The setup apparatus 10 includes a setup processing unit 101 and a storage unit 102.

The setup processing unit 101 executes the setup algorithm Setup, and generates and outputs the common parameter pp. The storage unit 102 stores information necessary for the execution of the setup algorithm Setup, output results thereof, and the like.

The key generation apparatus 20 is a computer or a computer system configured to generate the secret key sk. The key generation apparatus 20 includes a key generation processing unit 201 and a storage unit 202.

The key generation processing unit 201 executes the key generation algorithm KG and outputs the secret key sk. The storage unit 202 stores information necessary for the execution of the key generation algorithm KG, output results thereof, and the like.

The encryption apparatus 30 is a computer or a computer system configured to generate an encrypted text ct obtained by encrypting a plaintext m. The encryption apparatus includes an encryption processing unit 301 and a storage unit 302.

The encryption processing unit 301 executes the encryption algorithm Enc and outputs the encrypted text ct. The storage unit 302 stores information necessary for the execution of the encryption algorithm Enc, output results thereof, and the like.

The decryption apparatus 40 is a computer or a computer system configured to decode the encrypted text ct. The decryption apparatus 40 includes a decryption processing unit 401 and a storage unit 402.

The decryption processing unit 401 executes the decoding algorithm Dec and outputs the plaintext m or L indicating a decoding failure. The storage unit 402 stores information necessary for the execution of the decoding algorithm Dec, output results thereof, and the like.

The watermark embedding apparatus 50 is a computer or a computer system configured to embed a watermark into the decoding circuit. The watermark embedding apparatus 50 includes an embedding processing unit 501 and a storage unit 502.

The embedding processing unit 501 executes the watermark embedding algorithm Mark, and outputs the decoding circuit D embedded with a watermark M. The storage unit 502 stores information necessary for the execution of the watermark embedding algorithm Mark, output results thereof, and the like.

The watermark extraction apparatus 60 is a computer or a computer system configured to extract the watermark from the decoding circuit. The watermark extraction apparatus 60 includes an extraction processing unit 601 and a storage unit 602.

The extraction processing unit 601 executes the watermark extraction algorithm Ext, and outputs the watermark M from the decoding circuit embedded with the watermark. The storage unit 602 stores information necessary for the execution of the watermark extraction algorithm Ext, the output result thereof, and the like.

Note that the configuration of the electronic watermark embeddable encryption system 1 illustrated in FIG. 1 is an example, and other configurations may be employed. For example, the setup apparatus 10 and the key generation apparatus 20 may be configured as one apparatus, the key generation apparatus 20 and the encryption apparatus 30 may be configured as one apparatus, the encryption apparatus 30 and the watermark embedding apparatus 50 may be configured as one apparatus and the decryption apparatus 40 and the watermark extraction apparatus 60 may be configured as one apparatus.

Processing Flow Executed by Electronic Watermark Embeddable Encryption System 1 Next, a processing flow executed by the electronic watermark embeddable encryption system 1 according to the present embodiment will be described with reference to FIG. 2. FIG. 2 is a diagram illustrating an example of a processing flow executed by the electronic watermark embeddable encryption system 1 according to the present embodiment.

Firstly, the setup processing unit 101 of the setup apparatus 10 executes the setup algorithm Setup (1^{λ}) to generate and output a common parameter pp (step S101).

Next, the setup processing unit 101 of the setup apparatus 10 transmits the common parameter pp to the key generation apparatus 20, the watermark embedding apparatus 50, and the watermark extraction apparatus 60 (step S102 to step S104).

Next, the key generation processing unit 201 of the key generation apparatus 20 executes the key generation algorithm KG (pp) to generate and output a secret key sk (step S201).

Next, the key generation processing unit 201 of the key generation apparatus 20 transmits the secret key sk to the encryption apparatus 30, the decryption apparatus 40, and the watermark embedding apparatus 50 (step S202 to step S204). Note that in this case, the key generation processing unit 201 transmits the secret key sk through a secure communication method.

Subsequently, if an encryption function is utilized by the user, step S301 to step S303 are executed. That is, in this case, the encryption processing unit 301 of the encryption apparatus 30 executes the encryption algorithm Enc (sk, m) and outputs an encrypted text ct (step S301). Next, the encryption processing unit 301 of the encryption apparatus 30 transmits the encrypted text ct to the decryption apparatus 40 (step S302). Next, in receiving the encrypted text ct, the decryption processing unit 401 of the decryption apparatus 40 executes the decoding algorithm Dec (sk, ct) to decode the encrypted text ct (step S303).

On the other hand, if an electronic watermark function is utilized by the user, step S401 to step S403 are executed. That is, in this case, the embedding processing unit 501 of the watermark embedding apparatus 50 executes the watermark embedding algorithm Mark (pp, sk, M) and outputs a decoding circuit D embedded with a watermark M (step S401). Next, the embedding processing unit 501 of the watermark embedding apparatus 50 transmits the decoding circuit D to the watermark extraction apparatus 60 (step S402). Next, in receiving the decoding circuit D, the extraction processing unit 601 of the watermark extraction apparatus 60 executes the watermark extraction algorithm Ext (pp, D) to extract the watermark M from the decoding circuit D (step S403).

As described above, the electronic watermark embeddable encryption system 1 according to the present embodiment is capable of realizing the secret-key encryption allowing an electronic watermark to be embedded into the decoding circuit. Moreover, in the electronic watermark embeddable encryption system 1 according to the present embodiment, in both cases of embedding a watermark into the decoding circuit and extracting a watermark from the decoding circuit, it is possible to embed and extract the watermark without using the information possibly owned only by the system administrator. Thus, the electronic watermark embeddable encryption system 1 according to the present embodiment allows any user to embed and extract a watermark, and can be applied to a larger number of applications.

Hardware Configuration

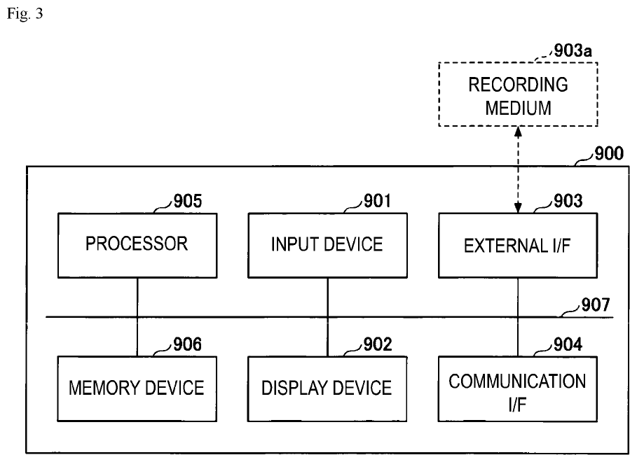

Finally, a hardware configuration of the setup apparatus 10, the key generation apparatus 20, the encryption apparatus 30, the decryption apparatus 40, the watermark embedding apparatus 50, and the watermark extraction apparatus 60 included in the electronic watermark embeddable encryption system 1 according to the present embodiment will be described. The setup apparatus 10, the key generation apparatus 20, the encryption apparatus 30, the decryption apparatus 40, the watermark embedding apparatus 50, and the watermark extraction apparatus 60 may be realized by a hardware configuration of a computer 900 illustrated in FIG. 3, for example. FIG. 3 is a diagram illustrating an example of the hardware configuration of the computer 900.

The computer 900 illustrated in FIG. 3 includes an input device 901, a display device 902, an external I/F 903, a communication IF 904, a processor 905, and a memory device 906.

Each of the hardware devices is communicatively connected via a bus 907.

The input device 901 is a keyboard, a mouse, or a touch panel, for example. The display device 902 is, for example, a display. Note that the computer 900 does not necessarily include at least one of the input device 901 and the display device 902.

The external I/F 903 is an interface with an external device. The external device includes a recording medium 903a and the like. The computer 900 is capable of reading from and writing to the recording medium 903a via the external I/F 903. The recording medium 903a may store, for example, one or more programs for realizing the setup processing unit 101 or the key generation processing unit 201, the encryption processing unit 301, the decryption processing unit 401, the embedding processing unit 501, and the extraction processing unit 601.

Examples of the recording medium 903a include a compact disc (CD), a digital versatile disc (DVD), a secure digital memory card (SD memory card), and a universal serial bus (USB) memory card.

The communication I/F 904 is an interface for connection with the communication network 70. The one or more programs for realizing the setup processing unit 101 or the key generation processing unit 201, the encryption processing unit 301, the decryption processing unit 401, the embedding processing unit 501, and the extraction processing unit 601 may be acquired (downloaded) from a predetermined server apparatus and the like via the communication I/F 904.

The processor 905 is, for example, various calculation devices such as a central processing unit (CPU) or a graphics processing unit (GPU). In the setup processing unit 101, one or more programs stored in the memory device 906 of the setup apparatus 10 are realized by processing to be executed by the processor 905 of the setup apparatus 10. Similarly, in the key generation processing unit 201, one or more programs stored in the memory device 906 of the key generation apparatus 20 are realized by processing to be executed by the processor 905 of the key generation apparatus 20. In the encryption processing unit 301, one or more programs stored in the memory device 906 of the encryption apparatus 30 are realized by processing to be executed by the processor 905 of the encryption apparatus 30. In the decryption processing unit 401, one or more programs stored in the memory device 906 of the decryption apparatus 40 are realized by processing to be executed by the processor 905 of the decryption apparatus 40. In the embedding processing unit 501, one or more programs stored in the memory device 906 of the watermark embedding apparatus 50 are realized by processing to be executed by the processor 905 of the watermark embedding apparatus 50. In the extraction processing unit 601, one or more programs stored in the memory device 906 of the watermark extraction apparatus 60 are realized by processing to be executed by the processor 905 of the watermark extraction apparatus 60.

The memory device 906 is, for example, any storage device such as a hard disk drive (HDD), a solid state drive (SSD), a random access memory (RAM), a read only memory (ROM), or a flash memory. The storage unit 102 may be realized using, for example, the memory device 906 of the setup apparatus 10. Similarly, the storage unit 202 may be realized using, for example, the memory device 906 of the key generation apparatus 20. The storage unit 302 may be realized using, for example, the memory device 906 of the encryption apparatus 30. The storage unit 402 may be realized using, for example, the memory device 906 of the decryption apparatus 40. The storage unit 502 may be realized using the memory device 906 of the watermark embedding apparatus 50. The storage unit 602 may be realized using the memory device 906 of the watermark extraction apparatus 60.

The setup apparatus 10, the key generation apparatus 20, the encryption apparatus 30, the decryption apparatus 40, the watermark embedding apparatus 50, and the watermark extraction apparatus 60 included in the electronic watermark embeddable encryption system 1 according to the present embodiment can realize the above-described processing by the hardware configuration of the computer 900 illustrated in FIG. 3. Note that the hardware configuration of the computer 900 illustrated in FIG. 3 is an example, and other hardware configurations may be employed. For example, the computer 900 may include a plurality of processors 905, and may include a plurality of memory devices 906.

The present invention is not limited to the above-described embodiment disclosed specifically, and various modifications or changes, combinations with known techniques, and the like can be made without departing from description of the claims.

### REFERENCE SIGNS LIST

1 Electronic watermark embeddable encryption system
10 Setup apparatus
20 Key generation apparatus
30 Encryption apparatus
40 Decryption apparatus
50 Watermark embedding apparatus
60 Watermark extraction apparatus
70 Communication network
101 Setup processing unit
102 Storage unit
201 Key generation processing unit
202 Storage unit
301 Encryption processing unit
302 Storage unit
401 Decryption processing unit
402 Storage unit
501 Embedding processing unit
502 Storage unit
601 Extraction processing unit
602 Storage unit

1. An electronic watermark embedding apparatus capable of embedding an electronic watermark into a decoding circuit of secret-key encryption, the apparatus comprising a processor configured to execute a method comprising:
receiving input including a common parameter generated in a setup of the secret-key encryption, a secret key of the secret-key encryption, and the electronic watermark; and
generating, based on the input, the decoding circuit embedded with the electronic watermark, the decoding circuit being capable of decoding an encrypted text encrypted using the secret-key encryption.

2. The electronic watermark embedding apparatus according to claim 1, wherein the common parameter includes a cyclic group G of an order p and a generator g of the cyclic group G,
the secret key includes an element x uniformly and randomly selected from a residue system modulo the p and a plurality of elements a uniformly and randomly selected from a set obtained by removing a zero element from the residue system modulo the p, and
the generating further comprises generating the decoding circuit hard-coded with a value calculated using the electronic watermark, the element x, the plurality of elements a, and the p, and the electronic watermark.

3. An electronic watermark extraction apparatus capable of extracting an electronic watermark embedded in a decoding circuit of secret-key encryption, comprising a processor configured to execute a method comprising:
receiving input including a combination of a common parameter generated by a setup of the secret-key encryption and the decoding circuit: and
extracting, based on the input, the electronic watermark embedded in the decoding circuit, the decoding circuit being capable of decoding an encrypted text encrypted using the secret-key encryption.

4. The electronic watermark extraction apparatus according to claim 3, wherein the common parameter includes a cyclic group G of an order p, and
the extraction further comprises:
randomly generating a plurality of generators of the cyclic group G, performs a calculation by a predetermined first circuit by being input with the plurality of generated generators and the decoding circuit, and performs a calculation by a predetermined second circuit by being input with the plurality of generated generators and the decoding circuit to extract, as the electronic watermark, an output of the second circuit.

5. The electronic watermark extraction apparatus according to claim 4, wherein the first circuit calculates a plurality of values h from a value y obtained by decoding, by the decoding circuit, first information including an element m uniformly and randomly selected from the cyclic group G, an element r uniformly and randomly selected from a set obtained by removing a zero element from a residue system modulo the p, and the plurality of generators, the element m, and the element r, and outputs a value h appearing a predetermined number of times or more from among the plurality of calculated values h,
the second circuit calculates a plurality of values z from a value y′ obtained by decoding, by the decoding circuit, second information including an element m uniformly and randomly selected from the cyclic group G, an element r uniformly and randomly selected from a set obtained by removing a zero element from a residue system modulo the p, and the plurality of generators, the element m, and the element h, and outputs a value corresponding to a value z appearing a predetermined number of times or more from among the plurality of calculated values z, and
the extracting further comprises using a value output from the second circuit, as information included in the electronic watermark to extract the electronic watermark.

6. A computer implemented method, comprising:
receiving input including a common parameter generated in a setup of secret-key encryption, a secret key of the secret-key encryption, and an electronic watermark; and
generating, based on the input, a decoding circuit embedded with an electronic watermark the decoding circuit being capable of decoding an encrypted text encrypted using the secret-key encryption.

7-8. (canceled)

9. The electronic watermark embedding apparatus according to claim 1,
wherein the encrypted text is based on music data.

10. The electronic watermark embedding apparatus according to claim 1,
wherein the setup of the secret-key encryption is associated with an administrative user, and wherein the decoding circuit is associated with a non-administrative user.

11. The electronic watermark extraction apparatus according to claim 3, wherein the encrypted text is based on music data.

12. The electronic watermark extraction apparatus according to claim 3, wherein the setup of the secret-key encryption is associated with an administrative user, and wherein the decoding circuit is associated with a non-administrative user.

13. The computer implemented method according to claim 6, wherein the common parameter includes a cyclic group G of an order p and a generator g of the cyclic group G,
the secret key includes an element x uniformly and randomly selected from a residue system modulo the p and a plurality of elements a uniformly and randomly selected from a set obtained by removing a zero element from the residue system modulo the p, and
the generating further comprises generating the decoding circuit hard-coded with a value calculated using the electronic watermark, the element x, the plurality of elements a, and the p, and the electronic watermark.

14. The computer implemented method according to claim 13, further comprising:
extracting the electronic watermark embedded in the decoding circuit by being input with the common parameter generated in the setup of the secret-key encryption and the decoding circuit.

15. The computer implemented method according to claim 6, wherein the encrypted text is based on music data.

16. The computer implemented method according to claim 6, wherein the setup of the secret-key encryption is associated with an administrative user, and wherein the decoding circuit is associated with a non-administrative user.

17. The computer implemented method according to claim 14, further comprising:
randomly generating a plurality of generators of the cyclic group G, performs a calculation by a predetermined first circuit by being input with the plurality of generated generators and the decoding circuit, and performs a calculation by a predetermined second circuit by being input with the plurality of generated generators and the decoding circuit to extract, as the electronic watermark, an output of the second circuit.

18. The computer implemented method according to claim 17, wherein the first circuit calculates a plurality of values h from a value y obtained by decoding, by the decoding circuit, first information including an element m uniformly and randomly selected from the cyclic group G, an element r uniformly and randomly selected from a set obtained by removing a zero element from a residue system modulo the p, and the plurality of generators, the element m, and the element r, and outputs a value h appearing a predetermined number of times or more from among the plurality of calculated values h,
the second circuit calculates a plurality of values z from a value y′ obtained by decoding, by the decoding circuit, second information including an element m uniformly and randomly selected from the cyclic group G, an element r uniformly and randomly selected from a set obtained by removing a zero element from a residue system modulo the p, and the plurality of generators, the element m, and the element h, and outputs a value corresponding to a value z appearing a predetermined number of times or more from among the plurality of calculated values z, and
the extracting further comprises using a value output from the second circuit, as information included in the electronic watermark to extract the electronic watermark.
